(19) United States
(12) Patent Application Publication
(10) Pub. No.: US 2023/0286422 A1
(43) Pub. Date: Sep. 14, 2023

(54) Pressure-Sensing Car Seat Device

(71) Applicant: Roger Fowler, Oklahoma City, OK (US)

(72) Inventor: Roger Fowler, Oklahoma City, OK (US)

(21) Appl. No.: 18/179,462

(22) Filed: Mar. 7, 2023

Related U.S. Application Data
(60) Provisional application No. 63/317,691, filed on Mar. 8, 2022.

(51) Int. Cl. B60N 2/28; B60N 2/00; B60Q 9/00; G08B 21/22; G08B 21/24

(52) U.S. Cl. CPC B60N 2/28; B60N 2/002; B60Q 9/00; G08B 21/22; G08B 21/24

(57) ABSTRACT

The present invention relates to a pressure-sensing car seat device that prevents a user from leaving a child behind in a vehicle unintentionally. The device is comprised of a child car seat with a pressure sensor/switch that detects the presence of a child within the device. A power cord places the device in electrical communication with the vehicle it is within such that when the vehicle turns off, the device loses power. If the device loses power and the pressure sensor/switch is still activated, the device may alert the user via a speaker, a mobile application, or functions of the vehicle that a child is still within the device.

### CROSS-REFERENCE TO RELATED APPLICATION

The present application claims priority to, and the benefit of, U.S. Provisional Application No. 63/317,691, which was filed on Mar. 8, 2022, and is incorporated herein by reference in its entirety.

### FIELD OF THE INVENTION

The present invention relates generally to the field of child car seats. More specifically, the present invention relates to a pressure-sensing car seat device. The device is comprised of a child car seat with a pressure sensor/switch that detects the presence of a child within the device. A power cord places the device in electrical communication with the vehicle it is within such that when the vehicle turns off the device loses power. If the device loses power and the pressure sensor/switch is still activated, the device may alert the user via a speaker, a mobile application, or functions of the vehicle that a child is still within the device. Accordingly, the present disclosure makes specific reference thereto. Nonetheless, it is to be appreciated that aspects of the present invention are also equally applicable to other like applications, devices, and methods of manufacture.

### BACKGROUND

Parents and caregivers can become distracted and may forget that a child is in the back seat of a vehicle. This is especially true if the child falls asleep or is otherwise quiet. Unfortunately, if a parent or caregiver exits a vehicle without remembering to remove the child from the vehicle, death of the child may occur.

Therefore, there exists a long-felt need in the art for a vehicle safety device for children. There also exists a long-felt need in the art for a pressure-sensing car seat device that notifies a driver or occupant of the presence of a child within the vehicle. More specifically, there exists a long-felt need in the art for a pressure-sensing car seat device that notifies a driver or occupant of the presence of a child within the vehicle once the vehicle has been turned off and the driver/occupant is preparing to exit the vehicle. In addition, there exists a long-felt need in the art for a pressure-sensing car seat device that notifies a driver or occupant of the presence of a child within the vehicle once the vehicle has been turned off and the driver/occupant is preparing to exit the vehicle in a plurality of different ways.

The subject matter disclosed and claimed herein, in one embodiment thereof, comprises a pressure-sensing car seat device. The device is primarily comprised of a car seat body with at least one pressure sensor and/or pressure switch, at least one power supply cord, at least one diagnostic plug, and at least one speaker. The body may be any car seat style, structure, size, configuration, etc., for any size and age of infant, child, or other user known in the art. The pressure sensor/switch detects the presence of a child within the body. The power cord places the device in electrical communication with the vehicle it is within such that when the vehicle turns off the device loses power. If the device loses power and the pressure sensor/switch is still activated, the device may alert the user via a speaker, a mobile application, or functions of the vehicle that a child is still within the device.

In this manner, the pressure-sensing car seat device of the present invention accomplishes all the foregoing objectives and provides a vehicle safety device for children in the form of a pressure-sensing car seat device. To ensure the safety of children within a vehicle, the device notifies a driver or occupant of the presence of a child within the vehicle once the vehicle has been turned off and the driver/occupant is preparing to exit the vehicle. In addition, the device notifies a driver or occupant of the presence of a child within the vehicle once the vehicle has been turned off and the driver/occupant is preparing to exit the vehicle in a plurality of different ways.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pressure-sensing car seat device primarily comprised of a car seat body with at least one pressure sensor and/or pressure switch, at least one power supply cord, at least one diagnostic plug, and at least one speaker. The body may be any car seat style, structure, size, configuration, etc., for any size and age of infant, child, or other user known in the art.

In one embodiment, the seat area of the body is comprised of at least one pressure sensor that detects the weight of an occupant present within the seat and/or body. The pressure sensor may be comprised of a threshold weight that prevents the sensor from activating if the threshold weight is not met and/or exceeded.

In a different embodiment, the seat area is comprised of at least one pressure plate that attaches to at least one pressure switch. The pressure switch is preferably positioned within an interior space of the base and below the plate. The switch may be comprised of a threshold weight that prevents the switch from activating if the threshold weight is not met and/or exceeded.

The device is also comprised of at least one diagnostic plug that can be plugged into a male diagnostic port within a vehicle interior to place the device in wired electrical communication with the vehicle. This allows the device to control functions of the vehicle. In a different embodiment, the device may be in wireless electrical communication with the electronic control unit of the vehicle via at least one transmitter of the device.

During use, the device detects when a vehicle has been turned off, via loss of power, to the device from at least one power supply cord. Once loss of power is detected, the device may notify the driver and/or vehicle occupants of the presence of a child still in the device if the threshold weight of the pressure sensor and/or pressure switch has been met and/or exceeded.

The device can notify the driver and/or vehicle occupants of the presence of a child in the device via a plurality of ways. In one embodiment, the device is comprised of at least one speaker that may produce a sound to notify the driver and/or vehicle occupants of the presence of a child in the device if the threshold weight of the pressure sensor and/or pressure switch has been met and/or exceeded. In one embodiment, once the loss of power is detected, the transmitter may communicate with the vehicle ECU to produce a sound, alarm, phrase, song, alert, etc., via the sound system (i.e., speakers) of the vehicle to notify the driver and/or vehicle occupants of the presence of a child in the device if the threshold weight of the pressure sensor and/or pressure switch has been met and/or exceeded. In a further embodiment, once the loss of power is detected, the transmitter may communicate with the mobile application to produce a sound, a call, a text, an email, a notification, an alert, etc., on the smart device the application is installed on to notify the driver and/or vehicle occupants of the presence of a child in the device if the threshold weight of the pressure sensor and/or pressure switch has been met and/or exceeded. In one embodiment, the device may also simultaneously control other functions of the vehicle via the communication with the ECU of the vehicle.

Accordingly, the pressure-sensing car seat device of the present invention is particularly advantageous as it provides a vehicle safety device for children in the form of a pressure-sensing car seat device. To ensure the safety of children within a vehicle, the device notifies a driver or occupant of the presence of a child within the vehicle once the vehicle has been turned off and the driver/occupant is preparing to exit the vehicle. In addition, the device notifies a driver or occupant of the presence of a child within the vehicle once the vehicle has been turned off and the driver/occupant is preparing to exit the vehicle in a plurality of different ways. In this manner, the pressure-sensing car seat device overcomes the limitations of existing child car seats known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pressure-sensing car seat device of the present invention in accordance with the disclosed architecture;

FIG. 2 illustrates a partially exploded perspective view of one potential embodiment of a pressure-sensing car seat device of the present invention in accordance with the disclosed architecture;

FIG. 3 illustrates a perspective view of one potential embodiment of a pressure-sensing car seat device of the present invention in accordance with the disclosed architecture;

FIG. 4 illustrates a perspective view of one potential embodiment of a pressure-sensing car seat device of the present invention in accordance with the disclosed architecture; and

FIG. 5 illustrates a representative illustration of a mobile application of one potential embodiment of a pressure-sensing car seat device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle safety device for children. There also exists a long-felt need in the art for a pressure-sensing car seat device that notifies a driver or occupant of the presence of a child within the vehicle. More specifically, there exists a long-felt need in the art for a pressure-sensing car seat device that notifies a driver or occupant of the presence of a child within the vehicle once the vehicle has been turned off and the driver/occupant is preparing to exit the vehicle. In addition, there exists a long-felt need in the art for a pressure-sensing car seat device that notifies a driver or occupant of the presence of a child within the vehicle once the vehicle has been turned off and the driver/occupant is preparing to exit the vehicle in a plurality of different ways.

The present invention, in one exemplary embodiment, is comprised of a pressure-sensing car seat device primarily comprised of a car seat body with at least one pressure sensor and/or pressure switch, at least one power supply cord, at least one diagnostic plug, and at least one speaker. The body may be any car seat style, structure, size, configuration, etc., for any size and age of infant, child, or other user known in the art.

In one embodiment, the seat area of the body is comprised of at least one pressure sensor that detects the weight of an occupant present within the seat and/or body. The pressure sensor may be comprised of a threshold weight that prevents the sensor from activating if the threshold weight is not met and/or exceeded.

In a different embodiment, the seat area is comprised of at least one pressure plate that attaches to at least one pressure switch that is preferably positioned within an interior space of the base and below the plate. The switch may be comprised of a threshold weight that prevents the switch from activating if the threshold weight is not met and/or exceeded.

At least one diagnostic plug of the device can be plugged into a male diagnostic port within a vehicle interior to place the device in wired electrical communication with the vehicle. This allows the device to control functions of the vehicle. In a different embodiment, the device may be in wireless electrical communication with the electronic control unit of the vehicle via at least one transmitter of the device.

During use, the device detects when a vehicle has been turned off, via loss of power to the device, from at least one power supply cord. Once loss of power is detected, the device may notify the driver and/or vehicle occupants of the presence of a child still in the device if the threshold weight of the pressure sensor and/or pressure switch has been met and/or exceeded.

The device can notify the driver and/or vehicle occupants of the presence of a child in the device via a plurality of ways. In a first embodiment, the device is comprised of at least one speaker that may produce a sound to notify the driver and/or vehicle occupants of the presence of a child in the device if the threshold weight of the pressure sensor and/or pressure switch has been met and/or exceeded. In a second embodiment, once the loss of power is detected, the transmitter may communicate with the vehicle ECU to produce a sound, alarm, phrase, song, alert, etc., via the sound system (i.e., speakers) of the vehicle to notify the driver and/or vehicle occupants of the presence of a child in the device if the threshold weight of the pressure sensor and/or pressure switch has been met and/or exceeded. In a third embodiment, once the loss of power is detected, the transmitter may communicate with the mobile application to produce a sound, a call, a text, an email, a notification, an alert, etc., on the smart device the application is installed on to notify the driver and/or vehicle occupants of the presence of a child in the device if the threshold weight of the pressure sensor and/or pressure switch has been met and/or exceeded. In one embodiment, the device may also simultaneously control other functions of the vehicle via the communication with the ECU of the vehicle.

Accordingly, the pressure-sensing car seat device of the present invention is particularly advantageous as it provides a vehicle safety device for children in the form of a pressure-sensing car seat device. To ensure the safety of children within a vehicle, the device notifies a driver or occupant of the presence of a child within the vehicle once the vehicle has been turned off and the driver/occupant is preparing to exit the vehicle. In addition, the device notifies a driver or occupant of the presence of a child within the vehicle once the vehicle has been turned off and the driver/occupant is preparing to exit the vehicle in a plurality of different ways. In this manner, the pressure-sensing car seat device overcomes the limitations of existing child car seats known in the art.

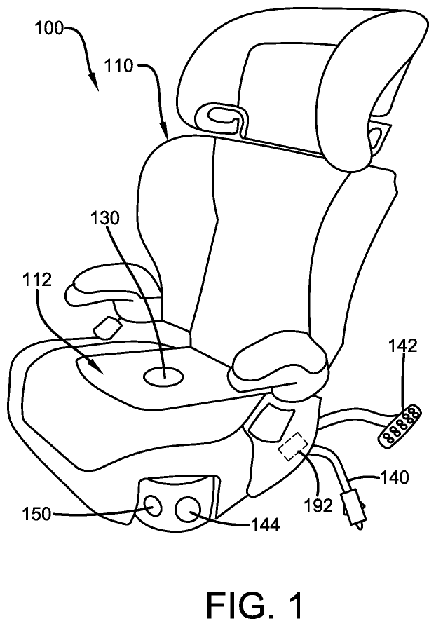

Referring initially to the drawings, FIG. 1 illustrates a perspective view of one potential embodiment of a pressure-sensing car seat device 100 of the present invention in accordance with the disclosed architecture. The device 100 is primarily comprised of a car seat body 110 with at least one pressure sensor 130 and/or pressure switch 134, at least one power supply cord 140, at least one diagnostic plug 142, and at least one speaker 144. The body 110 may be any car seat style, structure, size, configuration, etc., for any size and age of infant, child, or other user known in the art.

In one embodiment, the seat area 112 of the body 110 is comprised of at least one pressure sensor 130. The sensor 130 detects the weight of an occupant present within the seat 112 and/or body 110. In one embodiment, the sensor 130 may be positioned at, in, and/or on any location of the body 110. The pressure sensor 130 may be comprised of a threshold weight that prevents the sensor 130 from activating if the threshold weight is not met and/or exceeded. In the preferred embodiment, the threshold weight is at least 5 lbs. This prevents the sensor 130 from erroneously activating when no occupant is in the device 100.

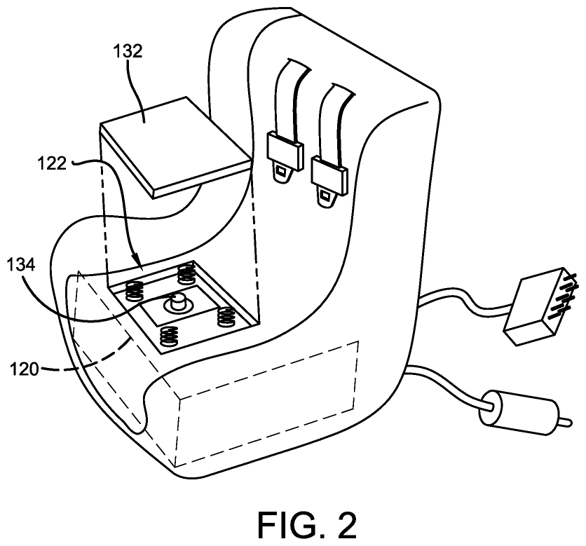

In a different embodiment, the seat area 112 is comprised of at least one pressure plate 132. The pressure plate 132 is preferably made from a padded or cushioned material for comfort. The pressure plate 132 attaches to at least one pressure switch 134 positioned within an interior space 122 of the base 120 and below the plate 132, as seen in FIG. 2. The switch 134 may be comprised of a threshold weight that prevents the switch 134 from activating if the threshold weight is not met and/or exceeded. In the preferred embodiment, the threshold weight is at least 5 lbs. to prevent the switch 134 from erroneously activating when no occupant is in the device 100.

The device 100 is also comprised of at least one diagnostic plug 142. The diagnostic plug 142 is preferably a female plug that can be plugged into a male diagnostic port within a vehicle interior. This connection places the device 100 in wired electrical communication with the vehicle via the plug 142 and allows the device 100 to control functions of the vehicle, as will be explained more fully below.

In a different embodiment, the device 100 may be in wireless electrical communication with the vehicle via at least one transmitter 150 of the device 100. The transmitter 150 may be in Bluetooth, Wi-Fi, RFID, etc., connection with an electronic control unit of a vehicle. In another embodiment, the transmitter 150 is in wireless electrical communication with a mobile application 200.

During use, the device 100 detects when a vehicle has been turned off via loss of power to the device 100 from at least one power supply cord 140. The cord 140 provides power to at least one battery 192 of the device 100 and may be a USB, a cigarette lighter, a 110 v/240 v male plug, or any other power supply cord known in the art. Once loss of power is detected, the device 100 may notify the driver and/or vehicle occupants of the presence of a child still in the device 100 if the threshold weight of the pressure sensor 130 and/or pressure switch 134 has been met and/or exceeded (via battery 192 power).

The device 100 can notify the driver and/or vehicle occupants of the presence of a child in the device 100 via a plurality of ways. In one embodiment, the device 100 is comprised of at least one speaker 144. Once loss of power is detected, the speaker 144 may produce a sound to notify the driver and/or vehicle occupants of the presence of a child in the device 100 if the threshold weight of the pressure sensor 130 and/or pressure switch 134 has been met and/or exceeded. In different embodiments, the speaker 144 may produce any sound, alarm, phrase, song, alert, etc.

In one embodiment, once the loss of power is detected, the transmitter 150 may communicate with the vehicle to produce a sound, alarm, phrase, song, alert, etc., via the sound system (i.e., speakers) of the vehicle, to notify the driver and/or vehicle occupants of the presence of a child in the device 100 if the threshold weight of the pressure sensor 130 and/or pressure switch 134 has been met and/or exceeded.

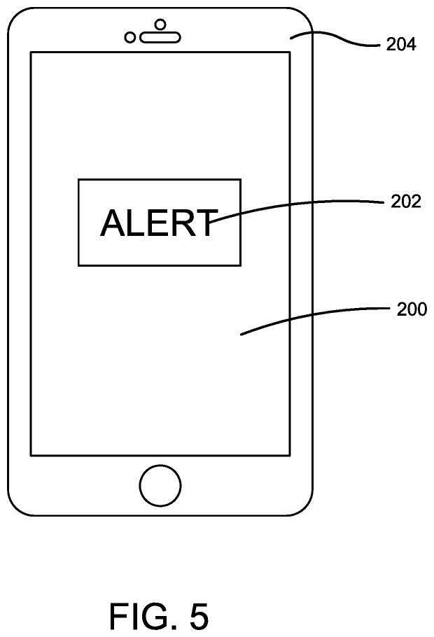

In a further embodiment, once the loss of power is detected, the transmitter 150 may communicate with the mobile application 200 to produce a sound, a call, a text, an email, a notification, an alert, etc., on the smart device 204 the application 200 is installed on to notify the driver and/or vehicle occupants of the presence of a child in the device 100 if the threshold weight of the pressure sensor 130 and/or pressure switch 134 has been met and/or exceeded, as seen in FIG. 5. In different embodiments, the mobile application 200 may produce any sound, alarm, phrase, song, alert, text, notification, email, etc.

In one embodiment, the device 100 may notify a driver and/or vehicle occupants via any combination of the notification methods described above. In one embodiment, the device 100 may also simultaneously control other functions of the vehicle via the communication with the ECU of the vehicle. This includes, but is not limited to, locking the vehicle, sounding the alarm system of the vehicle, honking the horn of the vehicle, controlling other auxiliary functions of the vehicle, etc., once the vehicle is detected as off and the pressure sensor 130 and/or pressure switch 134 detects the presence of a child in the device 100.

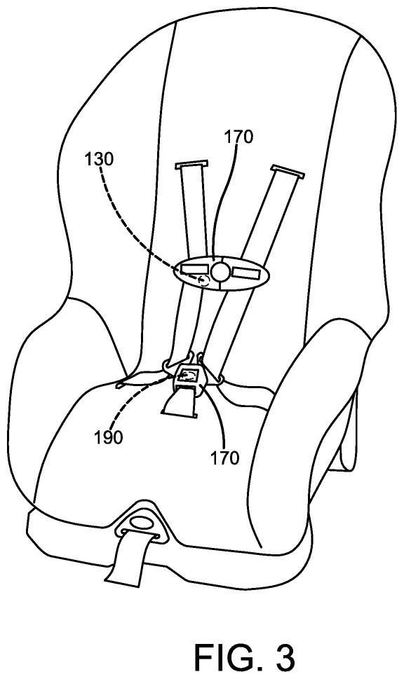

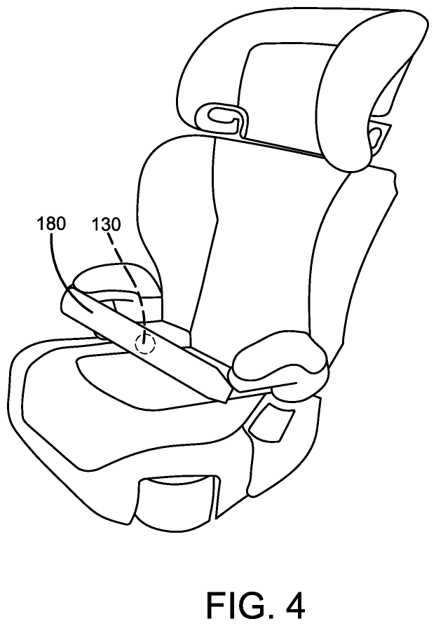

In a further embodiment, the sensor 130, switch, and/or pressure plate 132 may be positioned on any surface of a buckle 170 or restraint mechanism of the device 100 known in the art that secures a child within the device 100, as seen in FIG. 3. In a further embodiment, the device 100 may be comprised of bar-like restraint 180 that secures a child within the device 100, and wherein the sensor 130, switch, and/or pressure plate 132 may be positioned on any surface of the restraint 180 to detect occupancy of a child within the device 100, as seen in FIG. 4.

In another embodiment, at least one sensor 190 positioned within/on the buckle 170 and detects whether the buckle 170 is engaging a seat belt receptacle and/or the buckle 170 of the device 100 (to indicate whether a child is buckled into the device 100) as seen in FIG. 3. This embodiment alerts a user in the same manner as listed above if the device 100 loses power but the buckle 170 is still detected within the receptacle by the sensor 130.

In another embodiment, the buckle and receiver switch could be similar to that which is present in a driver seatbelt receiver, wherein the chime goes off until the driver fastens his or her seatbelt. In the present invention, the same technology could be used to detect the presence of a child in the seat in lieu of the pressure switch. Stated differently, if the seatbelt on the car seat is buckled, the system would assume the presence of a child in the seat and the pressure switch could be eliminated.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pressure-sensing car seat device” and “device” are interchangeable and refer to the pressure-sensing car seat device 100 of the present invention.

Notwithstanding the foregoing, the pressure-sensing car seat device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pressure-sensing car seat device 100 as shown in the FIGS. are for illustrative purposes only, and that many other sizes and shapes of the pressure-sensing car seat device 100 are well within the scope of the present disclosure. Although the dimensions of the pressure-sensing car seat device 100 are important design parameters for user convenience, the pressure-sensing car seat device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pressure-sensing car seat device comprising:
a body;
a pressure sensor;
a power supply cord;
a diagnostic plug; and
a speaker.

2. The pressure-sensing car seat device of claim 1, wherein the pressure sensor is comprised of a threshold weight.

3. The pressure-sensing car seat device of claim 2, wherein the speaker produces an audible alert when the threshold weight is met.

4. The pressure-sensing car seat device of claim 2, wherein the speaker produces an audible alert when the threshold weight is exceeded.

5. The pressure-sensing car seat device of claim 1, wherein the power supply cord is comprised of a cigarette lighter power cord.

6. The pressure-sensing car seat device of claim 1, wherein the diagnostic plug is comprised of a female diagnostic plug.

7. A pressure-sensing car seat device comprising:
a body;
a pressure plate;
a pressure sensor attached to the pressure plate;
a power supply cord;
a diagnostic plug; and
a speaker.

8. The pressure-sensing car seat device of claim 7, wherein the pressure switch is comprised of a threshold weight.

9. The pressure-sensing car seat device of claim 8, wherein the speaker produces an audible alert when the threshold weight is met.

10. The pressure-sensing car seat device of claim 8, wherein the speaker produces an audible alert when the threshold weight is exceeded.

11. The pressure-sensing car seat device of claim 7, wherein the power supply cord is comprised of a USB power cord.

12. A pressure-sensing car seat device comprising:
a body;
a pressure plate;
a pressure sensor attached to the pressure plate;
a power supply cord;
a diagnostic plug;
a speaker;
a transmitter; and
a mobile application.

13. The pressure-sensing car seat device of claim 12, wherein the pressure switch is comprised of a threshold weight.

14. The pressure-sensing car seat device of claim 13, wherein the mobile application produces an alert when the threshold weight is met.

15. The pressure-sensing car seat device of claim 14, wherein the alert is comprised of a sound, a call, a text, an email, or a notification.

16. The pressure-sensing car seat device of claim 12, wherein the mobile application produces an alert when the threshold weight is exceeded.

17. The pressure-sensing car seat device of claim 16, wherein the alert is comprised of a sound, a call, a text, an email, or a notification.

18. The pressure-sensing car seat device of claim 12, wherein the pressure plate is comprised of a padded material.

19. The pressure-sensing car seat device of claim 12, wherein the transmitter is comprised of a wireless transmitter.

20. The pressure-sensing car seat device of claim 12, wherein the power supply cord is comprised of a 110 v or 240 v male plug.
